(19) United States
(12) Patent Application Publication
(10) Pub. No.: US 2012/0283919 A1
(43) Pub. Date: Nov. 8, 2012

(54) Electric swing drive control system and method

(75) Inventors: Brian D. Kuras, East Peoria, IL (US); Christopher P. Braet, Peoria, IL (US)

(73) Assignee: CATERPILLAR INC., Peoria, IL (US)

(21) Appl. No.: 13/100,697

(22) Filed: May 4, 2011

(51) Int. Cl. B60L 15/00; G05B 5/01

(52) U.S. Cl. 701/50; 318/611

(57) ABSTRACT

A swing drive system for an upper structure of a machine includes an electric motor that receives electrical power and a torque command signal. A sensor provides a sensor signal indicative of a swing speed. An electronic controller provides the torque command signal to the electric motor in response to the command signal by receiving the command and sensor signals, providing the torque command signal to maintain a swing motion of the upper structure during a normal operating state, and providing the torque command signal based on the sensor signal to brake the swing motion at a substantially constant rate when the command signal is indicative of a zero desired swing speed during a braking operating state.

### TECHNICAL FIELD

This patent disclosure relates generally to control of electronically driven systems and, more particularly, to an electronically driven swing drive for an upper structure that is rotatably connected to an under carriage of a machine.

### BACKGROUND

Machines having rotatable upper structures are known. Examples of such machines include excavators, telescopic cranes and boom trucks, battle tanks, and others. Such machines may use different types of drive mechanisms to cause the selective rotation of an upper structure relative to an undercarriage. Known drive mechanisms include use of electric, hydraulic, or mechanical actuators. The type of drive mechanism used for each application will typically also dictate, in a fashion that is consistent for various machine types, the behavior of the machine. Electric drive systems, for example, may tend to drift when reaching a desired upper carriage position, while hydraulic drive systems may exhibit quicker stopping.

Based on the substantial similarity in the way machines operate depending on the type of drive that is used, experienced operators have developed skills within the framework of their expectations about how a machine will behave during operation. As can be appreciated, changes in the way a machine behaves during operation will not only decrease the productivity of an experienced operator, but may also pose safety considerations in that the various machine portions may not move exactly in a way that their operator expects them to.

Such issues of machine behavior during operation become especially pronounced when the drive systems are upgraded or otherwise redesigned, for example, when redesigning machine systems to improve their efficiency and to reduce overall machine fuel consumption. One example of a machine redesign along these lines is the conversion of a swing drive system from a hydraulic drive to an electric or hybrid-electric drive. It has been noted, for example, by operators testing an electrically-driven swing mechanism in excavators that the deceleration of the upper structure of the machine is inconsistent and sluggish when approaching zero speed or rest and can cause the upper structure's final rest position to have gone further than the operator's expectations and this is sometimes referred to as “machine drift.”

This issue has been recognized and at least one solution has been proposed in the past to address the different machine behavior when changing from a hydraulic to an electric swing drive system. An example of a control system for an electric swing motor that attempts to mimic machine operation with a hydraulic swing motor can be seen in U.S. Pat. No. 7,772,792, which was granted to Kawaguchi et al. on Aug. 10, 2010 (the '792 patent). The '792 patent describes a rotation control device for the rotary body of an excavator. The control device provides a small first torque command when rotating the rotary body, but can also provide a second, larger torque command when an acceleration is commanded. More specifically, in one embodiment of the '792 patent, a control system is described that includes numerous tables, which are populated with acceleration values that are determined based on a velocity command. The various tables are dedicated to emulating various effects of a hydraulic and mechanical systems of the excavator, such as hydraulic fluid pressure, rotating inertia of the rotary body depending on the position and loading of the bucket, and others. In this way, the device described in the '792 patent attempts to emulate the operation of a hydraulic system by use of the electric system by, for example, providing a slight deceleration when the rotary body is rotating to emulate the operation of a hydraulically motivated actuator when fluid is diverted from the swing actuator to actuate the boom and/or bucket actuators.

Even though the devices described in the '792 patent are at least partially effective in emulating the behavior of a hydraulically activated swing mechanism with an electric motor, the extensive tabulation of data is labor intensive and cannot automatically adapt to different operating conditions and loads. Moreover, the '792 patent discloses use of a mechanical brake to arrest rotation of the rotary body at the end of a swing, which has been found in other machines to be an unacceptable behavioral characteristic for operators besides presenting issues with the reliability and longevity of the braking mechanism. Also, the addition of a mechanical brake reduces the overall operating efficiency of the machine thus increasing fuel consumption.

### SUMMARY

The disclosure describes, in one aspect, a swing drive system for a machine. The machine may include an upper structure rotatably associated with an under carriage. The swing drive system can be adapted to selectively rotate the upper structure relative to the under carriage in response to a command signal from an operator of the machine. The swing drive system includes an electric power generator adapted for connection to an engine of the machine for receiving mechanical power therefrom to drive the generator. An electric swing motor is disposed to selectively receive electrical power. In addition, the motor receives a torque command signal to drive a sprocket that is adapted to mesh with a ring gear connected to the under carriage of the machine. A sensor is associated with the swing drive system and adapted to provide a sensor signal indicative of a swing speed of the upper structure relative to the under carriage. An electronic controller is associated with the sensor and the electric swing motor. The electronic controller is operable to provide the torque command signal to the electric swing motor in response to the command signal. The electronic controller is configured to receive the command signal and the sensor signal. The electronic controller can provide the torque command signal to maintain a swing motion of the upper structure in response to the command signal and based on the sensor signal during a normal operating state. The electronic controller can further provide the torque command signal based on the sensor signal to brake the swing motion at a substantially constant rate when the command signal is indicative of a zero desired swing speed during a braking operating state.

In another aspect, the disclosure describes a method for operating an electrically driven swing mechanism disposed to selectively swing an upper structure of a machine relative to an under carriage of the machine. The method includes providing an electronic controller operably associated with an electric swing drive motor and configured to provide a torque command to the electric swing drive motor. A driving torque command is provided to the electric swing drive motor that is sufficient to maintain a desired swing speed of the upper structure based on a command signal from an operator and based on an estimated speed of the upper structure relative to the under carriage. A braking torque command is provided to the electric swing drive motor that is sufficient to reduce a speed of the upper structure at a substantially constant rate based on the estimated speed of the upper structure relative to the under carriage when the command signal is indicative of a zero desired swing speed.

In yet another aspect, the disclosure describes a machine having an upper structure rotatably associated with an under carriage and a swing drive system configured to selectively rotate the upper structure relative to the under carriage in response to a command signal from an operator of the machine. The machine includes an electric power generator connected to an engine of the machine for receiving mechanical power therefrom to drive the generator and an electric swing motor disposed to selectively receive electrical power. In addition, the motor receives a torque command signal to drive a sprocket meshed with a ring gear connected to the under carriage of the machine. A sensor is associated with the swing drive system and disposed to provide a sensor signal indicative of a swing speed of the upper structure relative to the under carriage. An electronic controller is associated with the sensor and the electric swing motor. The electronic controller is operable to provide the torque command signal to the electric swing motor in response to the command signal. The electronic controller is configured to receive the command signal and the sensor signal. The electronic controller provides the torque command signal to maintain a swing motion of the upper structure in response to the command signal and based on the sensor signal during a normal operating state. The electronic controller further provides the torque command signal based on the sensor signal to brake the swing motion at a substantially constant rate when the command signal is indicative of a zero desired swing speed during a braking operating state.

### BRIEF DESCRIPTION OF THE DRAWINGS

FIG. 1 is a perspective view of an excavator in accordance with the disclosure.

FIG. 2 is a partially fragmented and sectioned perspective view of an excavator in accordance with the disclosure.

FIG. 3 is a perspective view of an undercarriage of the excavator shown in FIGS. 1 and 2, which has a swing motor having a sprocket engaged with a ring gear of the undercarriage in accordance with the disclosure.

FIG. 4 is a block diagram of a swing drive mechanism in accordance with the disclosure.

FIG. 5 is a block diagram of a swing drive control in accordance with the disclosure.

FIG. 6 is a state-flow diagram for a swing drive control in accordance with the disclosure.

FIG. 7 is an exemplary data trace of a method of controlling the swing of an upper structure of a machine in accordance with the disclosure.

### DETAILED DESCRIPTION

This disclosure relates to a machine that is configured to operate in a fashion consistent with a hydraulically-driven swing drive mechanism but that instead uses an electrically driven swing-drive mechanism. The electrically driven swing-drive mechanism can also provide advantages that are not available for the hydraulically-drive swing drive mechanism. In one aspect, the systems and methods disclosed herein are applicable to not only newly manufactured machines, but also to machines that are reconditioned, refurbished and/or retrofitted with electric systems to replace hydraulic systems.

As used herein, the term “machine” may refer to any machine that performs some type of operation associated with an industry such as mining, construction, fanning, transportation, marine or any other industry known in the art. For example, although an excavator is shown in certain figures, the machine may generally be an earth-moving machine, such as a wheel loader, excavator, dump truck, backhoe, motor grader, or may alternatively be any other type of machine, such as a material handler, a locomotive, paving machine or the like. Similarly, although an exemplary bucket is illustrated as the attached implement of the illustrated excavator, any implements may be utilized and employed for a variety of tasks, including, for example, loading, compacting, lifting, brushing, and include, for example, buckets, compactors, forked lifting devices, brushes, grapples, cutters, shears, blades, breakers/hammers, augers, and others.

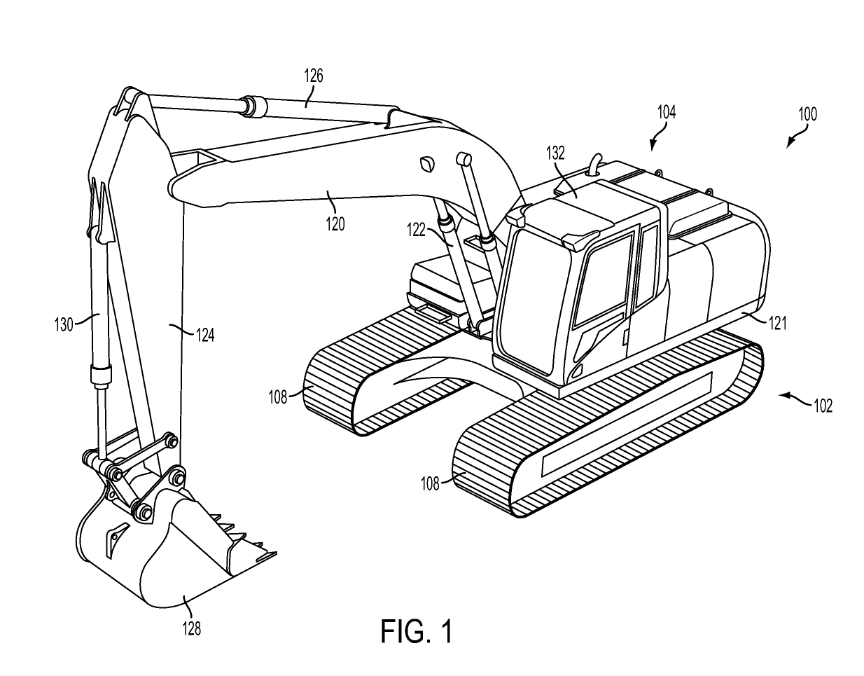

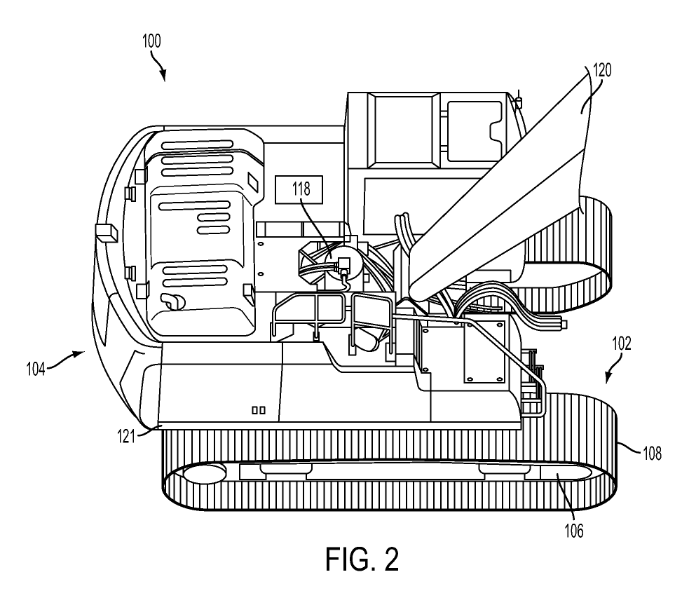

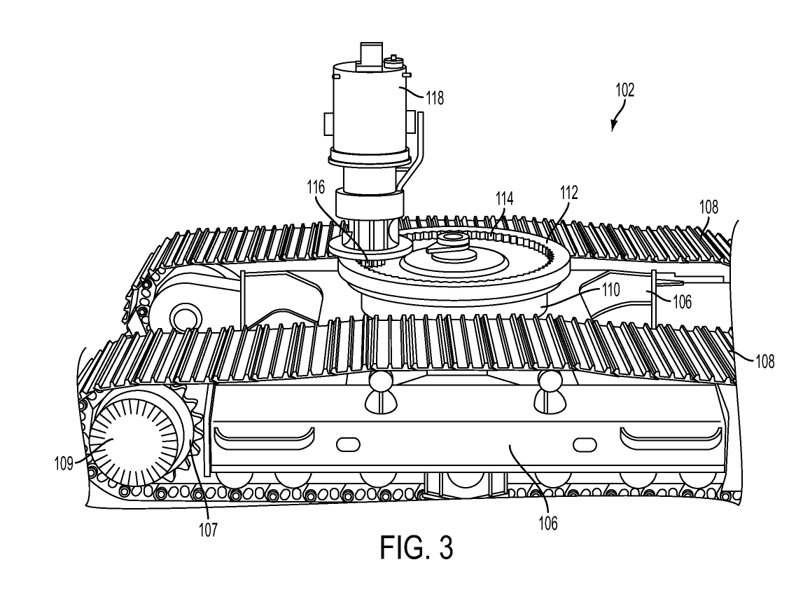

With the foregoing in mind, an excavator 100 is shown for purpose of illustration in FIG. 1. The excavator 100 includes an undercarriage 102 and an upper structure 104. The undercarriage 102, which is also shown in FIG. 3, includes a generally H-shaped frame 106 that supports two crawler tracks 108 along its edges and includes a post 110 supporting a ring gear 112 close to its center. The crawler tracks 108 are moved by sprockets 107 that are rotated by hydraulic drive motors or electric drive motors 109 connected to the frame 106. The ring gear 112 includes a plurality of teeth 114 arranged along its inner periphery, which mesh with a drive sprocket 116 powered by a swing motor 118. In reference to FIG. 2, the swing motor 118 is connected to the upper structure 104 such that rotation of the drive sprocket 116 causes the relative rotation of the upper structure 104 relative to the undercarriage 102.

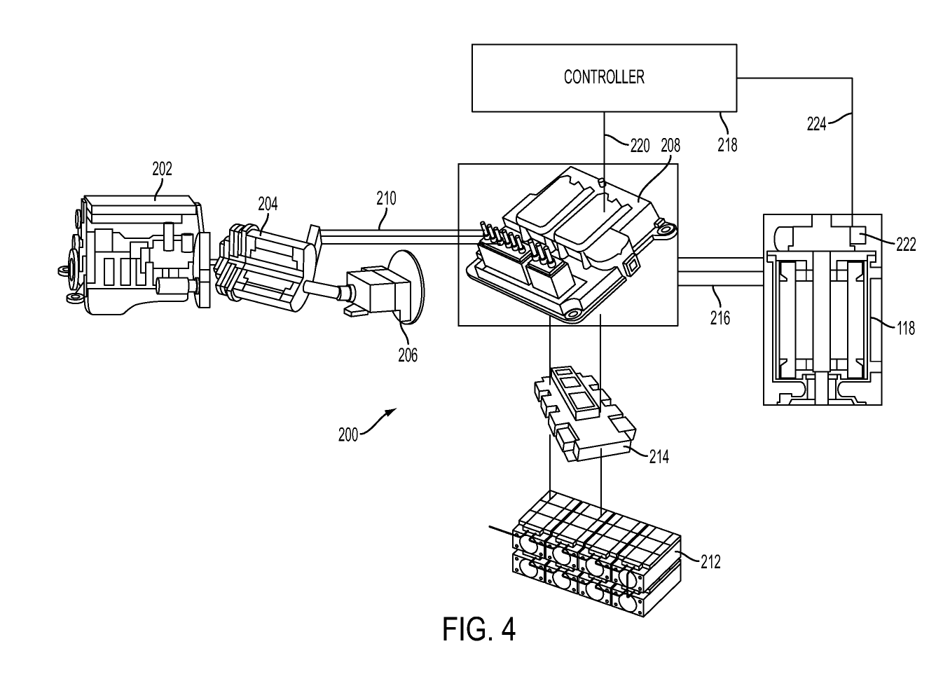

In reference now to FIGS. 1 and 2, the upper structure 104 includes a boom 120 that is pivotally connected to an upper structure frame 121 and pivoted by use of two boom actuators 122. An arm 124, which is also commonly referred to as a stick, is pivotally connected at an end of the boom 120 and pivoted by an arm actuator 126. A bucket 128 is connected at an end of the arm 124 and pivoted by a bucket actuator 130. The boom actuators 122, the arm actuator 126 and the bucket actuator 130 are embodied in the illustrations as linear hydraulic cylinders, which are configured to be extended and retracted by selective porting of pressurized fluid on one side of a hydraulic piston, as is known. The various functions of the machine 100 may be controlled in part by the appropriate handling of various control devices by an operator occupying a cab 132. In the past, a hydraulic pump was used to also power the swing motor 118, but in the illustrated embodiment the swing motor 118 is an electric motor. A block diagram for a swing drive system 200 is shown in FIG. 4.

As shown, the swing drive system 200 is an electrical drive or hybrid-electric drive system that includes an internal combustion engine 202 connected to an electric power generator 204. The engine 202 may be a compression ignition or diesel engine having an output shaft that is connected to a rotating group of the generator 204 such that electrical power can be generated during operation of the engine 202. In the illustrated embodiment, the generator 204 is configured to provide three-phase alternating current (AC) at about 480V, but any other electrical parameters or type of electrical power may be used. The engine 202 is further connected to a hydraulic pump 206, which provides pressurized hydraulic fluid to various components and systems of the machine 100 during operation. In the illustrated embodiment, the pump 206 is a reciprocating-piston type pump having a rotary input shaft that is connected to the engine 202 via the rotating group of the generator 204. In this way, mechanical power produced by the engine 202 is converted to electrical power at the generator 204 and to hydraulic power at the pump 206. Although a direct connection is shown between the engine 202, generator 204 and pump 206, any appropriate method of connection may be used. For example, gear sets, transmissions and any other type of mechanical transmission or transformation device may be used. Moreover, a switchable gear or isolation device may be used in transmitting power from the engine 202 to the generator 204 and/or the pump 206.

During operation, electrical power is transferred from the generator 204 to an inverter 208 by conduits 210 that electrically interconnect the inverter 208 with the generator 204. The inverter 208 is a device configured to transform the AC power provided on the conduits 210 to direct current (DC) power and vice versa. In the illustrated embodiment, DC electrical power from the inverter 208 can selectively be provided to a power storage device 212, which can include any appropriate type of electrical power storage such as batteries or an array of electrical capacitors. A bi-directional DC/DC converter 214 that is configured to manage or control the DC power flowing to and from the storage device 212 is electrically connected between the inverter 208 and the storage device 212.

Returning now to the inverter 208, a main power conduit 216 carrying AC power is connected to the electrical swing motor 118, which is also shown in FIGS. 2 and 3. The inverter 208 is configured to selectively provide electrical power that switches the direction and controls the torque and thus the speed of rotation of the swing motor 118. Control of the swing motor 118 in this way is carried out in response to appropriate control signals provided to the inverter 208 by a swing controller 218 via a communication line 220. A position sensor 222 is associated with the swing motor 118 and configured to provide a signal indicative of the rotational position of the upper structure 104 relative to the undercarriage 102 to the controller 218 via a communication line 224. In one embodiment, the position sensor 222 may be an encoder associated with the upper structure 104 and configured to measure its relative angular displacement relative to the ring gear 112 (FIG. 3). In the illustrated embodiment, the position sensor 222 is a speed sensor configured to measure relative displacement of an output shaft of the motor 118 that drives the sprocket 116 (FIG. 3) as an indication of the relative angular speed between the upper structure 104 and the undercarriage 102.

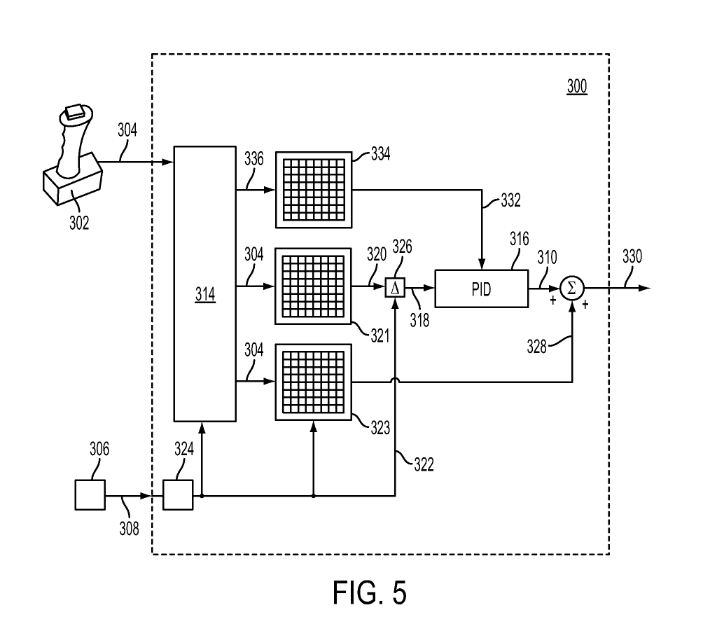

A block diagram for one embodiment of a swing control 300 that may be operating within the swing controller 218 is shown in FIG. 5. The swing control 300 is disposed to receive signals indicative of the desired and actual speed and/or position of the upper structure 104 relative to the undercarriage 102 of the machine 100, as shown in FIG. 1. The swing control 300 is connected to a control lever 302 via a communication line 304. The control lever 302 may be any appropriate type of operator control that can be displaced in a manner indicative of the operator's desired motion, acceleration and/or position of the upper structure 104 relative to the undercarriage 102. The control lever 302 may be positioned within the operator cab 132 (FIG. 1). As shown, the control lever 302 may provide information to the control 300 that is indicative of the desired swing of the upper structure, which can be expressed as a relative displacement based on its present position, as a desired speed, acceleration, or other parameters. A signal provided by the control lever 302 may also be indicative of the speed at which the operator desires the upper structure to move, for example, based on the extent at which the lever 302 is pushed, as well as the direction the operator wishes the upper structure to rotate in by pushing the lever 302 to one side or the other. All these indications can be acquired by an appropriate transducer that is configured to provide, in real time, the electrical signal 304 indicative of the motion of the lever 302 to the control 300.

The control 300 is further associated with a sensor 306, which is configured to provide information indicative of the position, direction, speed and/or acceleration of the upper structure 104 relative to the undercarriage 102 (FIG. 1) to the control 300 via a communication line 308. One example of the sensor 306 is the position sensor 222 shown and described above relative to FIG. 3. Based at least on the information provided to the control 300 regarding the desired motion of the upper structure by operator, as indicated by communication line 304 connected to control lever 302, and based on the position and motion of the upper structure 104, as provided by the communication line 308 from the sensor 306, the control 300 is configured to provide an appropriate command to the swing motor 118 (FIGS. 2, 3 and 4) via a command line 330. The torque signal carried on line 330 can be provided to other components and systems of the machine, such as the inverter 208 (FIG. 4), which operates as a switch for power provided to the motor 118.

In the illustrated embodiment, the signal 304 from the control lever 302 and the signal 308 from the sensor are provided to a state determinator 314. The state determinator 314 is configured to determine the desired speed, acceleration and/or position of the upper structure 104 when the control lever 302 is moved. The state determinator 314 may be further configured to determine the current speed, acceleration and/or position of the upper structure 104 based on signals received from the sensor 306. Parameters relating to the desired or actual position of the upper carriage, although potentially unnecessary for accomplishing the motion of the upper carriage, may be further determined in the state determinator 314 by appropriately calculating changes in position relative to a known position. The desired torque to be applied and the actual speed of the upper carriage, which are related parameters based on the moment of inertia of the upper carriage, may be determined based on a derivative-type or rate of change over time calculation of desired and actual position information. Similarly, the desired and actual acceleration of the upper carriage may be determined based on a derivative-type or rate of change over time calculation of desired and actual speeds, respectively. The state determinator 314 is further configured to determine changes in the direction of swing by, for example, monitoring speed, acceleration and/or position parameters as available and applicable.

In the embodiment illustrated in FIG. 5, the control 300 provides a desired torque command (magnitude and sign) to the swing motor 118 for swinging the upper structure in one direction or the other. In this way, a desired speed magnitude is determined based on the displacement of the control lever 302 by the operator. Similarly, a desired swing direction is determined based on the side at which the control lever 302 is displaced. In response to these desired direction and speed parameters, the control 300 provides a torque command (magnitude and sign), which are embodied in FIG. 5 as line 330.

The signal indicative of the torque request to be applied by the swing motor 118 (FIG. 4) is generally determined by a proportional, integral and derivative (PID) controller 316 having variable gains. The input 318 of the PID controller 316 is an error or difference between a desired speed 320 and an actual or measured speed magnitude 322. The desired speed magnitude 320 is provided from the state determinator 314 and is determined based on the signal 304 from the control lever 302 as previously described.

In the illustrated embodiment, the table 321 is activated to receive signals 304 during rotation of the upper structure by the operator. The estimated or measured speed magnitude 322 is determined at a calculation block 324 based on the signal 308 from the sensor 306 or by any other method, for example, by interrogation of the electrical current being provided to the swing motor 118 (FIG. 4). The calculation block 324 is configured to provide rotational speed (magnitude and direction) of the upper structure 104 based on time, position information provided by the sensor 306. The input 318, which represents the speed error or difference between the desired and actual magnitudes 320 and 322 is calculated at a difference calculator 326 and drives the PID controller 316.

When the control lever 302 is placed at a neutral position or a position indicating that the operators wishes the upper structure to stop swinging (hereinafter, zero position) while the upper structure is in motion, the state determinator 314 ceases to provide the signal 304 to the speed map 321 and stops outputting signal 320 and instead switches to provide the signal 304 to a braking map 323. The braking map 323 is populated with braking torque values that are required to provide an initial deceleration to the upper structure 104. In the illustrated embodiment, the signal 304 is provided to the braking map 323 to allow for operator adjustments during braking. Nevertheless, use of the signal 304 in this operating state, i.e., during braking of the upper structure, is optional and may be omitted such that the braking torque values 328 provided by the braking map 323 may be solely based on the measured speed magnitude 322. As can be appreciated, the braking torque value 328 is provided to replace the output of the PID controller 316 instead of being provided directly to the motor 118 through a junction 330, as shown in FIG. 5. In FIG. 5, the alternative use of the braking torque value 328 is shown in dashed-line arrow.

The PID controller 316 is further configured to operate using variable gains. As is known, a PID controller can typically use proportional, derivative and integral gains during operation, which are selected based on various structural aspects of a particular system as well as based on the desired dynamic response of the system. In the illustrated embodiment, the PID controller 316 is configured to receive its operating proportional, integral and/or derivative gains 332 from a gain schedule or gain table 334. The gain table 334 is populated with variable gain values that are selected based on a state input 336 provided by the state determinator 314, which in the illustrated embodiment is determined based on the signals 304 and 308.

More particularly, at least a first set of gains is provided in the gains table 334 for use during a first operating state at which the upper structure is swinging while the operator maintains the control lever 302 displaced to a certain degree. As can be appreciated, the first set of gains may include a single set of gain values 332 provided to the PID controller 316, or it may alternatively include ranges of gain values that are tabulated against the input signal 304 from the control lever 302.

The gains table 334 further includes at least a second set of gains for use during a second operating state at which the swing of the upper structure is undergoing braking after the operator restores the control lever 302 to the zero position. As in the first set of gains, the second set of gains may include a single set of gain values, which are more aggressive than the first set of values. Alternatively, the second set of gains may include a range of values that are selected based on the speed of the upper structure or, as shown in the illustrated embodiment, based on the signal 308 from the sensor 306. The signal 308 can be provided to the gains table 334 via the state determinator 314 when the control lever 302 is set to the zero position.

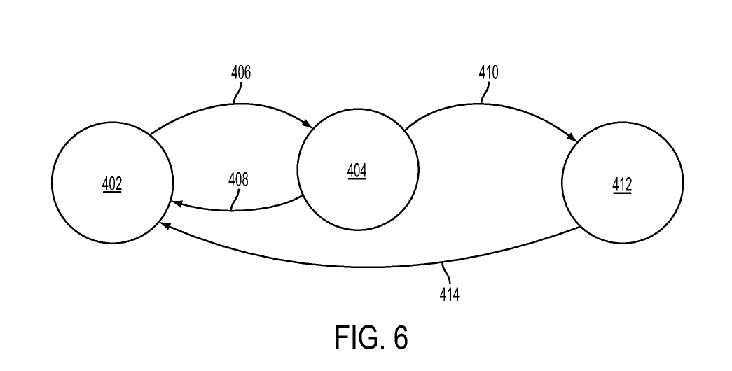

To better illustrate the operation of the swing control under various operating states, a state-flow diagram for a method of operating the swing control mechanism for an upper structure of a machine is shown in FIG. 6. At a first or normal operating state 402, a lever controlling the swing of the upper structure is at a non-zero position, which means that the operator of the machine desires motion of the upper structure in one direction or the other. For purpose of this discussion, the rotation of the upper structure will be described as being in a clockwise (CW) direction or a counter-clockwise (CCW) direction. During the normal operating state 402, the upper structure is rotating in the CW or CCW direction at an angular speed. The angular speed of the upper structure under this operating state may be substantially constant or variable, based on the operator's handling of the swing lever. The torque commanded to initiate or maintain rotation of the upper structure may be provided from a lookup table, as previously described, and controlled by a PID controller using a first or normal operating state set of gains.

The normal operating state 402 is active while the swing lever is at a non-zero position indicating that the operator is commanding a swing motion. When the swing lever is placed at the zero position, an initial deceleration or stopping operating state 404 is activated. With reference to FIG. 6, a transition 406 between the normal operating state 402 to the stopping operating state 404 occurs when the swing lever is placed at the zero position while the upper structure is still undergoing a swing motion. At the stopping operating state 404, an aggressive and nearly constant torque tending to brake or stop the swing of the upper structure is applied. In this way, a swing of the upper structure in the CW direction will be counter-acted by a braking torque applied in the CCW direction, and vice versa.

The magnitude of the braking torque applied when braking the upper structure may be determined by use of a relatively aggressive torque lookup table, which determines braking torque based on the swing speed magnitude of the upper structure, as previously described. In an alternative method, the braking torque may be determined by use of a PID controller operating with aggressive gains that are intended to emulate operation of the upper structure under a hydraulic swing drive system. The braking torque is applied while the swing lever is maintained at the zero position, which indicates that the operator still expects the upper structure to stop swinging. In the event that, during the stopping operating state 404 and before the speed of the upper structure reaches zero, the swing lever is moved from the zero position, a transition 408 switches back to the normal operating state 402.

The stopping operating state 404 is maintained until the speed of the upper structure reaches zero. Because of the rotational inertia of the upper structure and, in general, due to general overall system delays, even with the application of a zero torque request when speed reaches zero, the speed of the upper structure will cross zero speed and begin tending to rotate in the opposite (and undesired) direction. In other words, if swinging in the CW direction, the upper structure will stop and begin to slightly rotate in the CCW direction. When the swing of the upper structure changes direction, and while the swing lever is maintained at a zero position, a transition 410 will occur to a third or settling to zero speed operating state 412. In the illustrated embodiment, the settling operating state 412 is shown as separate from the normal operating state 402 for purpose of illustration but the two states may be integrated into a single operating state.

During operation in the settling to zero speed operating state 412, a controller provides less aggressive but appropriate torque commands to the swing motor such that the upper structure settles to a zero speed in a smooth and non-aggressive manner. Torque response during the settling to zero speed operating state 412 can be less aggressive than torque response in the stopping operating state 404 and the normal operating state 402. In one embodiment, for example, torque control at the stopping state 404 may emphasize the proportional component by having an aggressive proportional gain of a PID controller, while torque control at the settling to zero speed operating state 412 may de-emphasize the proportional component. Once speed has settled at zero, the controller may remain in the settling to zero speed operating state 412 until the swing lever is moved from the zero position. At that time, a transition 414 may switch operation back to the normal operating state 402 so that the appropriate swing may be carried out. The switching between the normal, braking and settling operating states 402, 404 and 412 may repeat each time an operator commands a swing.

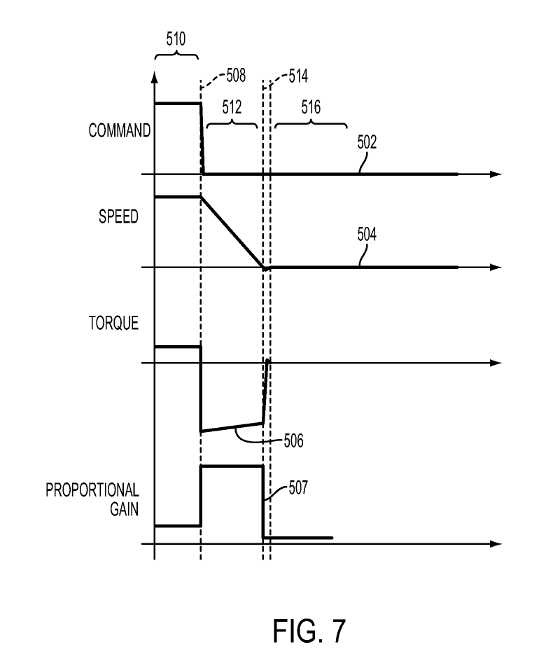

Certain qualitative graphs illustrating various operating parameters during an exemplary braking operation encompassing all three operating states previously discussed are shown in FIG. 7. In this way, a series of time-aligned qualitative charts are shown for the operator command 502, the swing speed magnitude 504 of the upper structure, the torque applied 506, and the magnitude of the proportional gain 507. The operator command 502 may be provided by the swing lever, which was also previously shown and discussed relative to FIG. 5 where the control lever 302 provided a signal 304. The swing speed magnitude 504 may be provided by an appropriate sensor, for example, the sensor 306 providing signal 308 (FIG. 5). The torque applied 506 may be a torque command provided by a controller to drive the swing motor, such as command 330 (FIG. 5). The proportional gain 507 may be a gain value used by a speed controller, for example, the PID 316 (FIG. 5). The horizontal line in each graph represents time. The combined graph further includes vertically extending dashed lines that demarcate the three operating states. Thus, a first line 508 separates a first state 510 from a second state 512, which correspond, respectively, to the normal operating state 402 and the braking operating state 404 as shown and discussed relative to FIG. 6 above. Similarly, a second line 514 separates the second state 512 from a third state 516. The third state corresponds to the settling operating state 412 (FIG. 6).

In the illustrated exemplary event, the command 502 is non-zero in the first state 510 until the first line 508 is reached. During the first state 510, the substantially constant command 502 causes a substantially constant swing speed magnitude 504, which may be in the CW or CCW direction. A maintenance torque 506 is provided during the first state 510 to overcome friction and maintain the swing speed magnitude 504. In this operating state the proportional gain 507 is at a normal operating level for the PID control. When the command crosses the first line 508 it drops to zero and, in the illustrated example, remains at zero through the second and third states 512 and 516. The speed 504 drops to zero over the duration of the second state 512 at a substantially constant downward slope. This type of aggressive and constant deceleration rate of the upper structure during the second state 512 is desired for controllability of the machine and is consistent with machines having hydraulic swing mechanisms. In this operating state the proportional gain 507 is high for the PID control to keep torque constant and aggressive all the way to zero speed. The speed 504 reaches zero at the second line 514, and undershoots the zero speed before settling to zero during the third state 516.

The torque 506 switches direction to oppose the swing motion of the upper structure when the second state 512 is initiated. As can be seen from the graph, the magnitude of the braking torque 506 during the second state 512 is larger than the driving torque 506 applied during the first state 510. The torque 506 non-aggressively reduces to zero during the third state 516 as the speed 504 settles to zero. In this operating state the proportional gain 507 is small for the PID control to prevent machine oscillations around zero speed. As shown, the value of the proportional gain 507 in this operating condition is lower than that used during the first state 510 but in an alternative embodiment a proportional gain that is the same as that of the first state 510 may be used.

### INDUSTRIAL APPLICABILITY

The present disclosure is applicable to machines having electrically driven swing mechanisms for upper structures rotatably associated with under carriages. In the past, certain applications that extensively used hydraulic systems, especially for operating their work implements, such as excavators and cranes, included hydraulically driven swing control mechanisms. In a typical hydraulically powered swing mechanism, a hydraulic pump provided pressurized fluid to a hydraulic swing motor to effect swing motion of the upper structure. When stopping the swinging motion of the upper structure with a hydraulically powered drive, the rotational momentum of the upper structure is primarily dissipated by use of relief valves that circulate fluid around a closed loop that includes the hydraulic swing motor. Such relief valves are configured to maintain a pressure at the outlet of the hydraulic swing motor, which provides a braking torque that aids to stop the swinging motion of the upper structure. When converting to an electrically powered swing control mechanism, however, a drift was noticed as the electrical controller associated with the electric swing motor settled to zero speed when braking the swing motion of the upper structure.

The functionality and system behavior that emulates a hydraulically operated swing control mechanism with an electrically driven swing motor is desirable for various reasons such as the avoidance for the need to re-train operators. To effectively provide the braking torque that is desired when the upper structure's swing is stopped, while still providing fine torque control during a swing, the disclosed systems and methods use an operating state-based control scheme. In a first state of operation, fine torque control can be provided by a PID controller during the swing. When a zero swing speed is desired, in one embodiment, the PID controller's gains are made aggressive to provide a more proportional-term-driven response in a second state of operation. Stated differently, control is taken away from the fine-control PID controller to provide sufficient braking torque. When most of the rotational momentum of the upper structure has been absorbed, fine control is once again provided in a third state of operation to help the upper structure settle to a zero speed.

In general, operation of the machine with an electrically powered swing control is more efficient and can provide consistent and reliable operation of the machine under various operating conditions. For example, in reference to FIG. 2, the power storage device 212 can be used to drive the generator 204 as a motor when additional power or torque is required to drive the pump 206. Moreover, electric retarding can be provided by the swing motor to charge the storage device 212 during braking to even further promote the efficient operation of the machine.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A swing drive system for a machine having an upper structure rotatably associated with an under carriage, the swing drive system adapted to selectively rotate the upper structure relative to the under carriage in response to a command signal from an operator of the machine, the swing drive system comprising:
an electric swing motor disposed to selectively receive electrical power and a torque command signal to drive a sprocket adapted to mesh with a ring gear connected to the under carriage of the machine;
a sensor associated with the swing drive system and adapted to provide a sensor signal indicative of a swing speed of the upper structure relative to the under carriage;
an electronic controller associated with the sensor and the electric swing motor, the electronic controller being operable to provide the torque command signal to the electric swing motor in response to the command signal, the electronic controller configured to:
receive the command signal;
receive the sensor signal;
provide the torque command signal to maintain a swing motion of the upper structure in response to the command signal and based on the sensor signal during a normal operating state; and
provide the torque command signal based on the sensor signal to brake the swing motion at a substantially constant rate when the command signal is indicative of a zero desired swing speed during a braking operating state.

2. The swing drive system of claim 1, wherein the electronic controller is further disposed to provide the torque command to settle the upper structure to a zero swing speed based on the sensor signal during a settling operating state, which is present after the braking operating state after the swing motion has changed direction.

3. The swing drive system of claim 2, wherein the electronic controller is configured to return to the normal operating state from the braking operating state when the command signal ceases to be indicative of the zero desired swing speed.

4. The swing drive system of claim 1, further comprising an inverter disposed on a conduit electrically interconnecting an electric power generator of the machine and the swing motor, the inverter connected to an electrical power storage device.

5. The swing drive system of claim 1, wherein the sensor signal is one of a position signal, a speed signal, and an acceleration signal, each of which is indicative of rotational motion between the upper structure and the under carriage.

6. The swing drive system of claim 1, wherein providing the torque command signal during the normal operating state includes:
providing the command signal to a torque map to determine a desired torque command signal;
providing the desired speed command signal as a setpoint to a proportional-integral-derivative (PID) controller;
providing the sensor signal as feedback to the PID controller; and
generating the torque command signal as an output of the PID controller.

7. The swing drive system of claim 6, wherein the PID controller operates using variable gains, which are determined based on a variable gain schedule relative to the command signal.

8. The swing drive system of claim 1, wherein providing the torque command signal during the braking operating state includes providing the sensor signal to a braking torque map to determine a desired braking torque command signal.

9. The swing drive system of claim 8, wherein providing the torque command signal during the braking operating state further includes:
providing the desired speed command signal as a setpoint to a proportional-integral-derivative (PID) controller;
providing the sensor signal as feedback to the PID controller;
generating the torque command signal as an output of the PID controller; and
operating the PID controller using variable gains, which are determined based on a variable gain schedule relative to the sensor signal.

10. A method for operating an electrically driven swing mechanism disposed to selectively swing an upper structure of a machine relative to an under carriage of the machine, comprising:
providing an electronic controller operably associated with an electric swing drive motor and configured to provide a torque command to the electric swing drive motor;
providing a driving torque command to the electric swing drive motor that is sufficient to maintain a desired swing speed of the upper structure based on a command signal from an operator and based on an estimated speed of the upper structure relative to the under carriage; and
providing a braking torque command to the electric swing drive motor that is sufficient to reduce a speed of the upper structure at a substantially constant rate based on the estimated speed of the upper structure relative to the under carriage when the command signal is indicative of a zero desired swing speed.

11. The method of claim 10, further comprising providing a settling torque command to the electric swing drive motor when the estimated speed of the upper structure changes direction.

12. The method of claim 10, wherein providing the driving torque command is accomplished in the electronic controller and includes:
providing the command signal to a torque map to determine a desired torque command signal;
providing the desired speed command signal as a setpoint to a proportional-integral-derivative (PID) controller;
providing the estimated speed of the upper structure as feedback to the PID controller; and
generating the driving torque command as an output of the PID controller.

13. The method of claim 12, further comprising operating the PID controller using variable gains, which are determined based on a variable gain schedule relative to the command signal.

14. The method of claim 10, wherein providing the braking torque command is accomplished in the electronic controller and includes providing the estimated speed of the upper structure to a braking torque map and determining a desired braking torque command from the braking torque map based on the estimated speed.

15. The method of claim 14, wherein providing the braking torque command further includes:
providing the desired speed command as a setpoint to a proportional-integral-derivative (PID) controller;
providing the estimated speed as feedback to the PID controller; and
generating the torque command as an output of the PID controller.

16. The method of claim 15, wherein the PID controller is operated using variable gains, which are determined based on a variable gain schedule relative to the estimated speed.

17. A machine having an upper structure rotatably associated with an under carriage and a swing drive system configured to selectively rotate the upper structure relative to the under carriage in response to a command signal from an operator of the machine, comprising:
an electric swing motor disposed to selectively receive electrical power and a torque command signal to drive a sprocket meshed with a ring gear connected to the under carriage of the machine;
a sensor associated with the swing drive system and disposed to provide a sensor signal indicative of a swing speed of the upper structure relative to the under carriage;
an electronic controller associated with the sensor and the electric swing motor, the electronic controller being operable to provide the torque command signal to the electric swing motor in response to the command signal, the electronic controller configured to:
receive the command signal;
receive the sensor signal;
provide the torque command signal to maintain a swing motion of the upper structure in response to the command signal and based on the sensor signal during a normal operating state; and
provide the torque command signal based on the sensor signal to brake the swing motion at a substantially constant rate when the command signal is indicative of a zero desired swing speed during a braking operating state.

18. The machine of claim 17, wherein the electronic controller is further disposed to provide the torque command to settle the upper structure to a zero swing speed based on the sensor signal during a settling operating state, which is present after the braking operating state after the swing motion has changed direction.

19. The machine of claim 17, wherein providing the torque command signal during the normal operating state includes:
providing the command signal to a torque map to determine a desired torque command signal;
providing the desired speed command signal as a setpoint to a proportional-integral-derivative (PID) controller;
providing the sensor signal as feedback to the PID controller; and
generating the torque command signal as an output of the PID controller;
wherein the PID controller operates using variable gains, which are determined based on a variable gain schedule relative to the command signal.

20. The machine of claim 17, wherein providing the torque command signal during the braking operating state includes:
providing the sensor signal to a braking torque map to determine a desired braking torque command signal;
providing the desired speed command signal as a setpoint to a proportional-integral-derivative (PID) controller;
providing the sensor signal as feedback to the PID controller;
generating the torque command signal as an output of the PID controller; and
operating the PID controller using variable gains, which are determined based on a variable gain schedule relative to the sensor signal.
